(19) United States
(12) Patent Application Publication
(10) Pub. No.: US 2023/0096854 A1
(43) Pub. Date: Mar. 30, 2023

(54) DATA PROCESSING SYSTEM, OPERATING METHOD THEREOF, AND COMPUTING SYSTEM USING DATA PROCESSING SYSTEM

(71) Applicant: SK hynix Inc., Icheon (KR)

(72) Inventors: Young Jae JIN, Icheon (KR); Ki Young KIM, Icheon (KR); Sang Eun JE, Icheon (KR)

(21) Appl. No.: 17/705,068

(22) Filed: Mar. 25, 2022

(30) Foreign Application Priority Data
Sep. 24, 2021 (KR) 10-2021-0126490

(51) Int. Cl. G06N 3/063; G06N 3/04; G06K 9/62

(52) U.S. Cl. CPC G06N 3/063; G06N 3/04; G06K 9/6261

(57) ABSTRACT

A data processing system includes a controller and a computation device. The controller receives a request for processing a neural network computation from a host, the request including an input feature map and a weight filter. The computation device includes a storage unit allocated to each of integration groups, and performs a convolution operation on the input feature map and the weight filter, sequentially outputs pooling elements as a result of the convolution operation, and performs a pooling operation on the pooling elements. The pooling elements corresponds to each integration group. The computation device performs the pooling operation by integrating a pooling value read from the storage unit and each of the pooling elements into a single value and updating the pooling value stored in the storage unit with a result of the integrating. The integrating and the updating are repeated until all of the pooling elements are integrated.

### CROSS-REFERENCES TO RELATED APPLICATION

The present application claims priority under 35 U.S.C. § 119(a) to Korean patent application number 10-2021-0126490, filed on Sep. 24, 2021, in the Korean Intellectual Property Office, which is incorporated herein by reference in its entirety.

### BACKGROUND

### 1. Technical Field

Various embodiments generally relate to a data processing technology, and more particularly, to a data processing system for neural network computation, an operating method thereof, and a computing system using the data processing system.

### 2. Related Art

With an increase in interest and importance for artificial intelligence applications and big data analysis, demands for a computing system capable of efficiently processing large amounts of data are increasing.

Artificial neutral networks are one way for implementing artificial intelligence. The purpose of artificial neutral networks is to enhance the problem-solving ability of a machine, that is, the reasoning ability of the machine, through learning. However, an increase in the accuracy of an output of the machine may cause an increase in an amount of computation, the number of accesses to a memory, a data storage space, and an amount of data movement.

This may cause a decrease in speed of the computation and increase power consumption, and the like, resulting in a degradation of system performance.

### SUMMARY

A data processing system according to an embodiment of the present technology may include: a controller configured to receive a request including an input feature map and a weight filter from a host device, wherein the request is for processing a neural network computation; and a computation device including a storage unit allocated to each of a plurality of integration groups, and configured to perform a convolution operation on the input feature map and the weight filter, sequentially output a plurality of pooling elements as a result of the convolution operation, and perform a pooling operation on the plurality of pooling elements, the plurality of pooling elements corresponding to each of the plurality of integration groups, wherein the computation device is configured to perform the pooling operation by: integrating a pooling value read from the storage unit and each of the plurality of pooling elements into a single value; and updating the pooling value stored in the storage unit with a result of the integrating, wherein the integrating and the updating are repeated until all of the plurality of pooling elements are integrated.

A data processing system according to an embodiment of the present technology may include: a computation memory configured to receive a request including an input feature map and a weight filter from a host device, sequentially perform a convolution operation on the weight filter and each of a plurality of division maps included in the input feature map, and sequentially output each of a plurality of pooling elements as a result of the convolution operation; a global buffer including a storage unit allocated to each of a plurality of integration groups, the plurality of pooling elements corresponding to each of the plurality of integration groups; a pooling controller configured to receive each of the plurality of pooling elements from the computation memory, read out a pooling value from the storage unit, and provide said each of the plurality of pooling elements and the pooling value to a pooler; and the pooler configured to integrate said each of the plurality of pooling elements and the pooling value into a single value, so that the pooling value stored in the storage unit is updated with a result of the integrating, wherein the integrating and the updating are repeated until all of the plurality of pooling elements are integrated.

An operating method of a data processing system according to an embodiment of the present technology may include: allocating, by a controller, a storage unit to each of a plurality integration groups; receiving, by the controller, a request including an input feature map and a weight filter from a host device; performing, by a computation device, a convolution operation on the input feature map and the weight filter; sequentially outputting, by the computation device, a plurality of pooling elements as a result of performing the convolution operation, the plurality of pooling elements corresponding to each of the plurality of integration groups; integrating, by the computation device, a pooling value read from the storage unit and each of the plurality of pooling elements into a single value; and updating, by the computation device, the pooling value of the storage unit according to a result of the integrating, wherein the integrating and the updating are repeated until all of the plurality of pooling elements are integrated.

A computing system according to an embodiment of the present technology may include: a host device; and a data processing system configured to: receive a request including an input feature map and a weight filter from the host device; perform a convolution operation on the input feature map and the weight filter; sequentially output a plurality of pooling elements as a result of performing the convolution operation, the plurality of pooling elements corresponding to each of a plurality of integration groups; allocate a storage unit to each of the plurality of integration groups; integrate a pooling value read from the storage unit and each of the plurality of pooling elements into a single value; and update the pooling value stored in the storage unit with a result of the integrating, wherein the integrating and the updating are repeated until all of the plurality of pooling elements are integrated.

### BRIEF DESCRIPTION OF THE DRAWINGS

FIG. 1 illustrates a computing system in accordance with an embodiment.

FIG. 2 illustrates the concept of data processing of an artificial neutral network in accordance with an embodiment.

FIG. 3 illustrates the concept of computation of a convolution layer.

FIG. 4 illustrates the concept of computation of a pooling layer.

FIG. 5 illustrates a neutral network processor in accordance with an embodiment.

FIG. 6 illustrates a pooling controller in accordance with an embodiment.

FIG. 7 illustrates a pooler in accordance with an embodiment.

FIG. 8 illustrates a computation memory in accordance with an embodiment.

FIG. 9A to FIG. 9H illustrate the concept of data reuse in accordance with an embodiment.

### DETAILED DESCRIPTION

Hereinafter, embodiments of the present technology will be described in more detail with reference to the accompanying drawings.

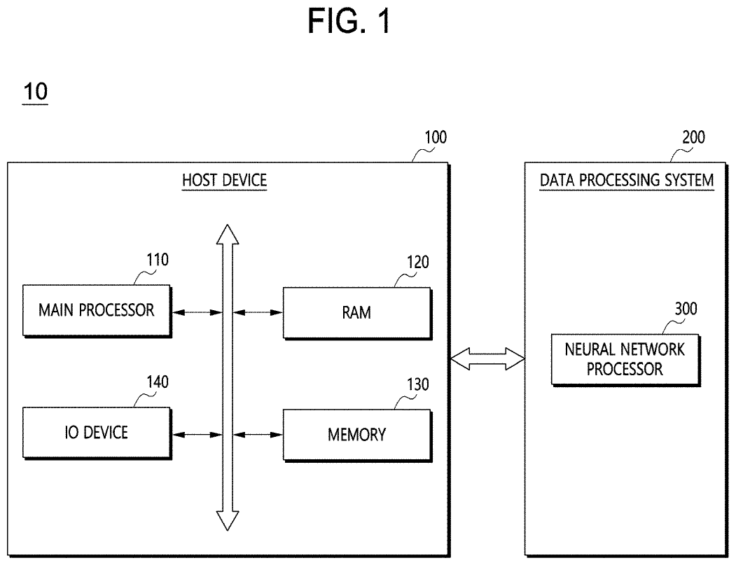

FIG. 1 illustrates a computing system 10 in accordance with an embodiment.

The computing system 10 may include a host device 100 and a data processing system 200 that processes the computation of an application requested by the host device 100.

The host device 100 may include a main processor 110, a random access memory (RAM) 120, a memory 130, and an input/output (IO) device 140, and may further include other general-purpose components (not illustrated).

In an embodiment, the components of the host device 100 may be implemented as a system-on chip (SoC) integrated into one semiconductor chip; however, embodiment are not limited thereto. In another embodiment, the components of the host device 100 may be implemented as a plurality of semiconductor chips.

The main processor 110 may control the overall operation of the computing system 10, and may be, for example, a central processing unit (CPU). The main processor 110 may include one core or a plurality of cores. The main processor 110 may process or execute programs, data, and/or instructions stored in the RAM 120 and the memory 130. For example, the main processor 110 may control functions of the computing system 10 by executing the programs stored in the memory 130.

The RAM 120 may temporarily store the programs, the data, or the instructions. The programs and/or the data stored in the memory 130 may be temporarily loaded into the RAM 120 according to a control or booting code of the main processor 110. The RAM 120 may be implemented using a dynamic RAM (DRAM), a static RAM (SRAM), or the like.

The memory 130 is a storage space for storing data, and may store, for example, an operating system (OS), various programs, and various data. The memory 130 may include at least one of a volatile memory and a nonvolatile memory. The nonvolatile memory may be selected from among a read only memory (ROM), a programmable ROM (PROM), an electrically programmable ROM (EPROM), an electrically erasable and programmable ROM (EEPROM), a flash memory, a phase-change RAM (PRAM), a magnetic RAM (MRAM), a resistive RAM (RRAM), a ferroelectric RAM (FRAM), and the like. The volatile memory may be selected from among a dynamic RAM (DRAM), a static RAM (SRAM), a synchronous DRAM (DRAM), and the like. Furthermore, in an embodiment, the memory 130 may be implemented as a storage device such as a hard disk drive (HDD), a solid-state drive (SSD), a compact flash (CF), a secure digital (SD), a micro-secure digital (micro-SD), a mini-secure digital (mini-SD), an extreme digital (xD), a memory stick, or the like.

The IO device 140 may receive user input or data from an exterior, and output a data processing result of the computing system 10. The IO device 140 may be implemented as a touch screen panel, a keyboard, various types of sensors, and the like. In an embodiment, the IO device 140 may collect information around the computing system 10. For example, the IO device 140 may include an imaging device and an image sensor, sense or receive an image signal from the outside of the data processing system 200, convert the sensed or received image signal into digital data, and store the digital data in the memory 130 or provide the digital data to the data processing system 200.

The data processing system 200 may extract valid information, such as images, voices, texts, and the like, from input data by analyzing the input data using an artificial neural network in response to a request of the host device 100. The data processing system 200 may determine a surrounding situation that the data processing system 200 is monitoring on the basis of the extracted valid information or control components of an electronic device in which the data processing system 200 is mounted based on the extracted valid information. For example, the data processing system 200 may be applied to a drone, an advanced driver assistance system (ADAS), a smart TV, a smart phone, a medical device, a mobile device, a video display device, a measurement device, an Internet of things (IoT) device, or the like, and may be mounted in one of various types of computing systems.

In an embodiment, the host device 100 may offload a neural network computation onto the data processing system 200, and provide the data processing system 200 with initial parameters for performing the neural network computation. For example, the initial parameters may include input data and weights.

In an embodiment, the data processing system 200 may be an application processor mounted in a mobile device.

The data processing system 200 may include at least a neural network processor 300.

The neural network processor 300 may generate a neural network model by training or learning input data, generate an information signal by computing the input data according to the neural network model, or re-train the neural network model. The neural network may include any of various types of neural network models including a convolution neural network (CNN), a region with convolution neural network (R-CNN), a region proposal network (RPN), a recurrent neural network (RNN), a stacking-based deep neural network (S-DNN), a state-space dynamic neural network (S-SDNN), a deconvolution network, a deep brief network (DBN), a restricted Boltzmann machine (RBM), a fully convolutional network, a long short-term memory (LSTM) network, a classification network, and the like. However, embodiments are not limited thereto.

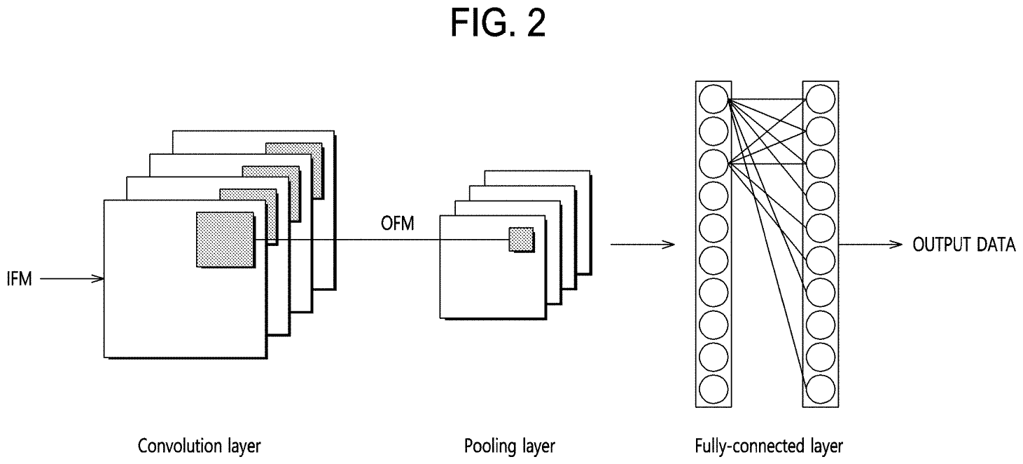

FIG. 2 illustrates the concept of data processing of an artificial neutral network in accordance with an embodiment, and, in particular, illustrates the concept of data processing of a CNN.

The CNN may be composed of a convolution layer, a pooling layer, and a fully connected layer.

The convolution layer may generate an output feature map OFM by applying a weight filter (kernel, W) to an input feature map IFM.

The pooling layer adds spatial invariance to features included in the output feature map OFM extracted through the convolution layer, and thus reduces a size of the output feature map OFM of the convolution layer.

The convolution layer and the pooling layer reduce the complexity of an entire neural network model by considerably reducing the number of parameters of the neural network. In addition, the data processing through the use of the convolution layer and the pooling layer may be repeatedly performed a plurality of times.

The fully connected layer may generate output data by classifying input data according to feature extraction results outputted from the pooling layer.

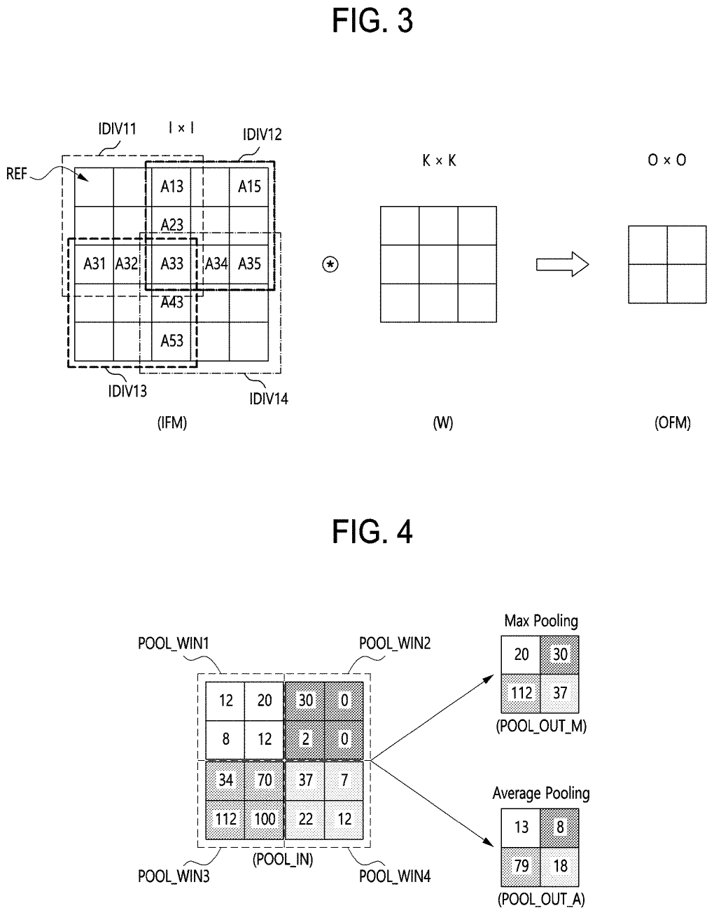

FIG. 3 illustrates the concept of computation of the convolution layer of FIG. 2.

The input feature map IFM and the weight filter W may each be provided in the form of a matrix. In the following description, unless otherwise specified, each of the input feature map IFM and the weight filter W needs to be understood to be a matrix having a set dimension (row*column) or size.

In order to apply the weight filter W to the input feature map IFM, the input feature map IFM may be divided into a plurality of division maps each having a dimension corresponding to the dimension of the weight filter W. For example, referring to FIG. 3, the input feature map IFM may be divided into division maps IDIV11 to IDIV14 by sliding a convolution window, which has a size corresponding to the dimension of the weight filter W, at predetermined intervals (stride) using an element on a first row 1 and a first column 1 of the input feature map IFM as a reference element REF. Furthermore, the output feature map OFM may be generated by sequentially applying the weight filter W to each of the division maps IDIV11 to IDIV14, that is, by performing a multiplication and accumulation (MAC) operation on the weight filter W and each of the division maps IDIV11 to IDIV14. The MAC operation is performed on each element in the weight filter W and a corresponding element in each of the division maps IDIV11 to IDIV14.

FIG. 3 illustrates that the size of the input feature map IFM is I*I (I=5), the size of the weight filter W is K*K (K=3), and the stride is 2. The number of division maps is determined to be (I−K)*(I−K). The output feature map OFM having a size of O*O (O=I−K) is obtained by performing a convolution operation on a division map and the weight filter W multiple times (cycles) corresponding to the number of division maps. In the above example shown in FIG. 3, the convolution operation is performed on each of the division maps IDIV11 to IDIV14 and the weight filter W in order to generate the output feature map OFM. That is, the convolution operation is performed 4 times.

The convolution operation is performed by sliding the convolution window in a row direction or a column direction by the stride (=2), starting from a first convolution cycle in which the weight filter W is applied to the first division map IDIV11 including the reference element REF. When the convolution window slides or moves in the row direction by the stride (=2) and the convolution operation is performed on the division map IDIV12 including the last element A15 in the row direction, the window slides in the column direction. Then, by repeating a process of performing the convolution operation by sliding the convolution window again in the row direction, the convolution operation on each of the division maps IDIV11 to IDIV14 and the weight filter W is performed, so that the output feature map OFM is acquired.

Referring to FIG. 3, it can be understood that, when the weight filter W is applied to each of the division maps IDIV11 to IDIV14 of the input feature map IFM, the weight filter W is repeatedly used in every convolution operation cycle and at least some elements of the division maps IDIV11 to IDIV14 are repeatedly used in the convolution operation cycle.

For example, referring to FIG. 3, after the convolution operation is performed on the first division map IDIV11 and the weight filter W in a first convolution cycle, elements A13, A23, and A33 used in the first convolution cycle are reused when the convolution operation is performed on the second division map IDIV12 and the weight filter W in a second convolution cycle.

When the convolution operation is performed on the third division map IDIV13 and the weight filter W in a third convolution cycle, elements A31, A32, and A33 used in the first convolution cycle and the element A33 used in the second convolution cycle are reused.

When the convolution operation is performed on the fourth division map IDIV14 and the weight filter W in a fourth convolution cycle, elements A33, A34, and A35 used in the second convolution cycle and elements A33, A43, and A53 used in the third convolution cycle are reused.

As described above, the convolution operation is performed for each of the division maps IDIV11 to IDIV14. As a result, the output feature map OFM having the size of 2*2 is acquired. Elements of the output feature map OFM respectively correspond to results of the convolution operations performed for the division maps IDIV11 to IDIV14.

The neural network processor 300 may include a plurality of processing elements PEs and a global buffer that transmits/receives data to/from the processing elements PEs.

Data used for the convolution operation, that is, the weight filter W and the input feature map IFM, may be provided from the global buffer to the processing elements PEs. In an embodiment, the convolution operation for each element of each of the division maps IDIV11 to IDIV14 may be performed by an independent processing element PE. Detailed description of the global buffer and the processing element PE will be described below.

FIG. 4 illustrates the concept of computation of the pooling layer of FIG. 2.

A pooling operation may be an operation for reducing a size of input data POOL_IN, that is, a size of data outputted from the convolution layer. The pooling operation is an operation of integrating the data, which is outputted from the convolution layer, into a single value for each pooling window that is an integration group, and may be performed by a max pooling method, an average pooling method, or the like.

The max pooling method is a method of dividing the input data POOL_IN into a plurality of pooling windows POOL_WIN1 to POOL_WIN4 each having a preset size and generating output data POOL_OUT_M by selecting a maximum value from among values in each of the plurality of pooling windows POOL_WIN1 to POOL_WIN4 while sliding the pooling window POOL_WIN according to a pooling stride.

The average pooling method is a method of generating output data POOL_OUT_A by calculating an average of the values in each of the plurality of pooling windows POOL_WIN1 to POOL_WIN4.

In general, the pooling window POOL_WIN may be a square matrix, a size of a row or a column of the pooling window POOL_WIN and the pooling stride may be set to substantially the same value, and all elements of the input data POOL_IN may be pooled once. FIG. 4 illustrates a case where the size of a row (or column) of the pooling window POOL_WIN and the pooling stride are 2.

The input data POOL_IN used for the pooling operation may be provided from the global buffer or the processing elements PEs of the neural network processor 300, and at least a part of an intermediate operation result generated in the pooling operation may be stored in the global buffer.

Each of the elements constituting the output feature map OFM, which is a result of the convolution operation performed on each division map IDIV and the weight filter W in the convolution cycle performed before the pooling operation, may be sequentially outputted from the plurality of processing elements PEs whenever the convolution operation is performed. In FIG. 3, nine processing elements PEs corresponding to the number of elements of each of the division maps IDIV11 to IDIV14 may perform an element-wise multiplication, and the multiplication results may be summed to acquire each of the elements of the output feature map OFM.

The pooling layer may receive convolution operation results corresponding to the number of elements included in the pooling window POOL_WIN, and perform the pooling operation on the convolution operation results. Referring to FIG. 4, the pooling operation is performed a plurality of times with a pooling window POOL_WIN having a size of 2*2 and a pooling stride of 2 with respect to input data POOL_IN having a size of 4*4. Furthermore, the convolution operation results corresponding to 4, which is the number of elements included in the pooling window POOL_WIN, are used in the pooling operation.

Elements of the input data POOL_IN are sequentially outputted whenever a unit convolution operation is performed in the convolution layer, and the pooling layer performs the pooling operation by sequentially receiving pooling elements for each pooling window.

Referring to FIG. 4, when elements (12, 20, 8, 12) included in the first pooling window POOL_WIN1, elements (30, 0, 2, 0) included in the second pooling window POOL_WIN2, elements (34, 70, 112, 100) included in the third pooling window POOL_WIN3, and elements (37, 7, 22, 12) included in the fourth pooling window POOL_WIN4 are all stored in the global buffer and are subjected to the pooling operation, a memory space capable of storing all the elements constituting the input data POOL_IN is required.

Accordingly, a memory space required for the pooling operation increases in proportion to the size of the input data POOL_IN to be processed.

Accordingly, the present technology proposes a method capable of minimizing a storage space of input data used for a pooling operation.

In an embodiment, the neural network processor 300 of FIG. 1 may allocate a pooling value storage unit to the global buffer for each pooling window. The pooling value storage unit may represent a unit storage in the global buffer that is to store a result of a pooling operation performed on elements included in each pooling window. The neural network processor 300 performs a pooling operation by pooling elements included in a pooling window, that is, pooling elements for each pooling window as the elements are sequentially provided, and updating the pooling value storage unit in the global buffer with a result of the pooling operation. That is, since the convolution operation is sequentially performed on each division map, the neural network processor 300 performs the pooling operation on elements that are sequentially output from the convolution layer instead of performing the pooling operation after all the elements for each pooling window are provided, and updates the global buffer with the result of the pooling operation. Thus, it is not necessary to store all the elements for each pooling window.

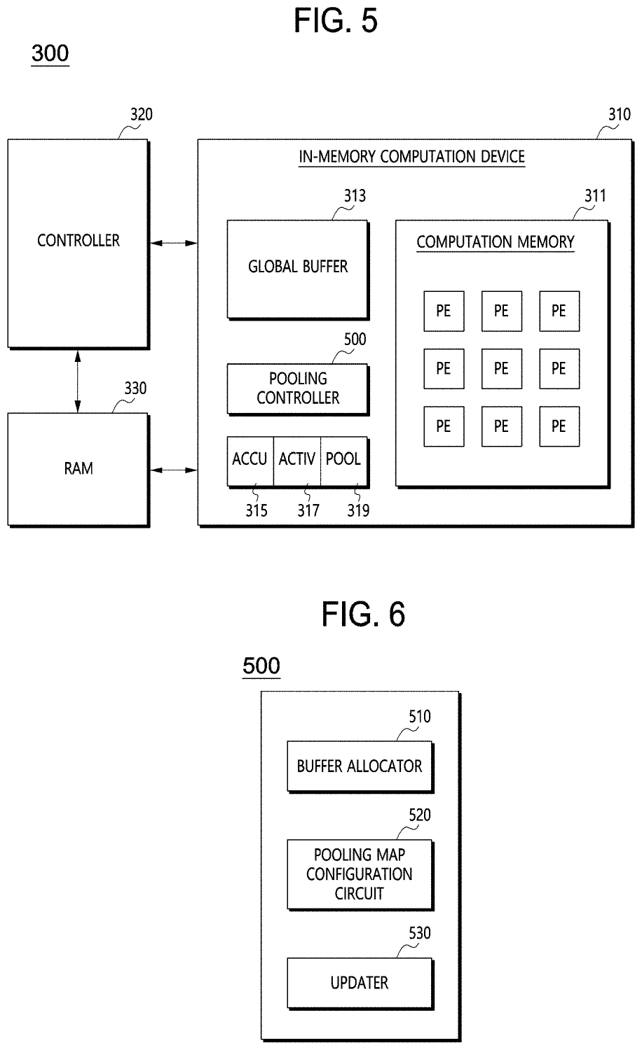

FIG. 5 illustrates the neutral network processor 300 of FIG. 1 in accordance with an embodiment.

Referring to FIG. 5, the neural network processor 300 may be a processor or an accelerator specialized for a neural network computation, and may include an in-memory computation device 310, a controller 320, and a RAM 330. In an embodiment, the neural network processor 300 may be implemented as a system-on chip (SoC) integrated into one semiconductor chip. However, embodiments are not limited thereto. In another embodiment, the neural network processor 300 may also be implemented as a plurality of semiconductor chips.

The controller 320 may control the overall operation of the neural network processor 300. The controller 320 may set and manage parameters related to the neural network computation, so that the in-memory computation device 310 may normally perform the neural network computation. The controller 320 may be implemented in the form of a combination of hardware, software, and software (or firmware) executed on hardware.

The controller 320 may be implemented with at least one processor, for example, a central processing unit (CPU), a microprocessor, or the like, and may execute instructions stored in the RAM 330 in order to implement various functions.

The RAM 330 may be a DRAM, an SRAM, or the like, and may store various programs, instructions, and data for the operation of the controller 320 and data generated by the controller 320.

The in-memory computation device 310 may be configured to perform the neural network computation under the control of the controller 320. The in-memory computation device 310 may include a computation memory 311, a global buffer 313, an accumulator (ACCU) 315, an activator (ACTIV) 317, a pooler (POOL) 319, and a pooling controller 500.

The computation memory 311 may include a plurality of processing elements PEs. The plurality of processing elements PEs may perform a convolution operation on the input feature map IFM and the weight filter W provided from the global buffer 313. For example, the convolution operation is an element-wise multiplication and accumulation. Therefore, a processing element PE performs the convolution operation on an element of the input feature map IFM and a corresponding element of the weight filter W.

The global buffer 313 may store the input feature map IFM and the weight filter W and then provide them to the computation memory 311. The global buffer 313 may store at least a part of data outputted from the computation memory 311, the ACCU 315, the ACTIV 317, and the POOL 319. The global buffer 313 may be implemented as a DRAM, an SRAM, or the like.

The ACCU 315 may be configured to derive a weighted sum by accumulating processing results of the plurality of processing elements PEs.

The ACTIV 317 may be configured to add nonlinearity to the weighted sum by applying the weighted sum of the ACCU 315 to an activation function such as ReLU.

The POOL 319 may be configured to sample the convolution operation result of the computation memory 311. In an embodiment, the POOL 319 samples an output value of the ACTIV 317, and reduces and optimizes a dimension of the output value.

The processing performed by the computation memory 311, the ACCU 315, the ACTIV 317, and the POOL 319 may be a process of training or re-training a neural network model, or a process of inferring input data.

The pooling controller 500 may be configured to control a method of transferring input data and output data of the POOL 319 so that only a part of data used by the POOL 319 is stored in the global buffer 313.

In an embodiment, the pooling controller 500 may be configured to sequentially provide the POOL 319 with pooling elements outputted from the computation memory 311 for each of a plurality of pooling windows without storing all the pooling elements in the global buffer 313, and to update the pooling value storage unit for each of the plurality of pooling windows according to an operation result of the POOL 319.

FIG. 6 illustrates the pooling controller 500 of FIG. 5 in accordance with an embodiment. The pooling controller 500 may be implemented with at least one processor.

Referring to FIG. 6, the pooling controller 500 may include a buffer allocator 510, a pooling map configuration circuit 520, and an updater 530.

The buffer allocator 510 may allocate a pooling value storage unit to each of a plurality of pooling windows. The global buffer 313 of FIG. 5 includes the pooling value storage unit allocated to each of the plurality of pooling windows.

The pooling map configuration circuit 520 may classify pooling elements, which are sequentially outputted from the computation memory 311 of FIG. 5, to form each of the plurality of pooling windows. Each of the polling elements is included in a corresponding one of the plurality of pooling windows.

The updater 530 may provide the POOL 319 of FIG. 5 with the pooling elements sequentially outputted from the computation memory 311, and update the pooling value storage unit of the global buffer 313 according to a pooling result for each pooling window. The pooling result is outputted from the POOL 319.

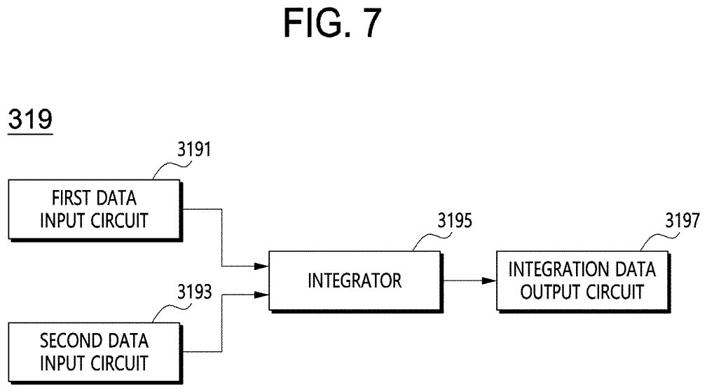

FIG. 7 illustrates the POOL 319 of FIG. 5 in accordance with an embodiment.

Referring to FIG. 7, the POOL 319 may include a first data input circuit 3191, a second data input circuit 3193, an integrator 3195, and an integration data output circuit 3197.

In an embodiment, first data provided to the first data input circuit 3191 may be convolution data sequentially outputted from the computation memory 311 of FIG. 5. That is, the first data is a pooling element for each pooling window. Second data provided to the second data input circuit 3193 may be data output from a pooling value storage unit of the global buffer 313 of FIG. 5 that is allocated to each pooling window.

The integrator 3195 may perform a pooling operation on first output data provided by the first data input circuit 3191 and second output data provided by the second data input circuit 3193. The pooling operation may be an operation for determining a maximum value between the first output data and the second output data or an operation for determining an average value of the first output data and the second output data. However, the pooling operation is not limited thereto.

The integration data output circuit 3197 may output an operation result of the integrator 3195 to the global buffer 313 to update the pooling value storage unit for each pooling window with the operation result of the integrator 3195.

An initial value may be stored in the pooling value storage unit before the pooling operation is started for each pooling window, and as the pooling operation is started, the pooling value storage unit may be updated according to the pooling progress for the first data provided to the first data input circuit 3191 and the second data provided to the second data input circuit 3193.

As the first data is provided to the first data input circuit 3191 directly from the PE in the computation memory 311 without going through the global buffer 313 and is integrated with immediately preceding pooling data that is the second data, the global buffer 313 does not need to store all pooling data.

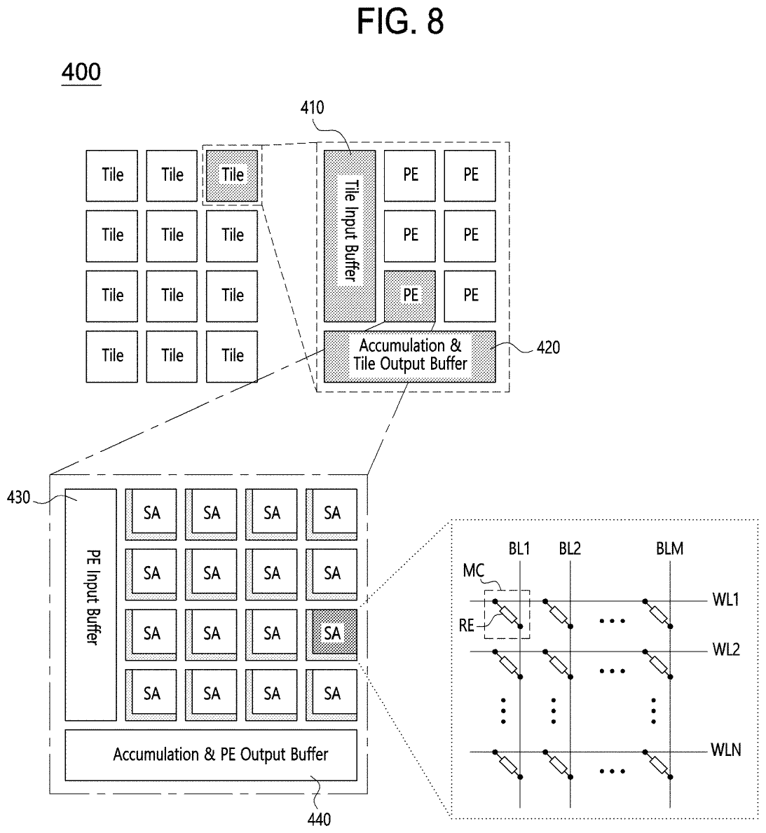

FIG. 8 illustrates a computation memory 400 in accordance with an embodiment. The computation memory 400 illustrated in FIG. 8 may correspond to the computation memory 311 shown in FIG. 5.

Referring to FIG. 8, the computation memory 400 may include a plurality of tiles.

Each tile may include a tile input buffer 410, a plurality of processing elements PEs, and an accumulation and tile output buffer 420.

Each processing element PE may include a PE input buffer 430, a plurality of subarrays SA, and an accumulation and PE output buffer 440.

A subarray SA may be referred to as a synapse array, and may include a plurality of word lines WL1 to WLN, a plurality of bit lines BL1 to BLM, and a plurality of memory cells MCs, M and N being positive integers. In an embodiment, a memory cell MC may include a resistive memory element RE, preferably, a memristor element; however, embodiments are not limited thereto. The memory cell MC including the resistive memory element RE may be referred to as a resistive memory cell MC. A data value stored in the resistive memory cell MC may be changed by a write voltage applied to the resistive memory cell MC through a corresponding one of the plurality of word lines WL1 to WLN or a corresponding one of the plurality of bit lines BL1 to BLM. The resistive memory cell MC may store data by such a change in resistance of the resistive element RE due to the write voltage.

In an embodiment, a resistive memory cell may be a phase-change random access memory (PRAM) cell, a resistive random access memory (RRAM) cell, a magnetic random access memory (MRAM) cell, a ferroelectric random access memory (FRAM) cell, or the like.

A resistive element RE constituting a resistive memory cell MC may include a phase-change material whose crystal state changes according to an amount of current applied thereto, a perovskite compound, a transition metal oxide, a magnetic material, a ferromagnetic material, an antiferromagnetic material, or the like. However, embodiments are not limited thereto.

When a unit cell of the subarray SA includes a memristor element, the processing element PE may store data corresponding to each element of the weight filter W in the memristor element, apply voltages corresponding to each element of a division map IDIV to the word lines WL1 to WLN, and perform a convolution operation by using Kirchhoff's law, Ohm's law, or the like.

When a size of a convolution operation window is, for example, 2*2, four processing elements PEs are required to perform the convolution operation for four elements of each division map IDIV in each convolution cycle. The subarray SA included in the processing element PE may be at least partially activated on the basis of the number of reuses of a reused element and the size of the weight filter W.

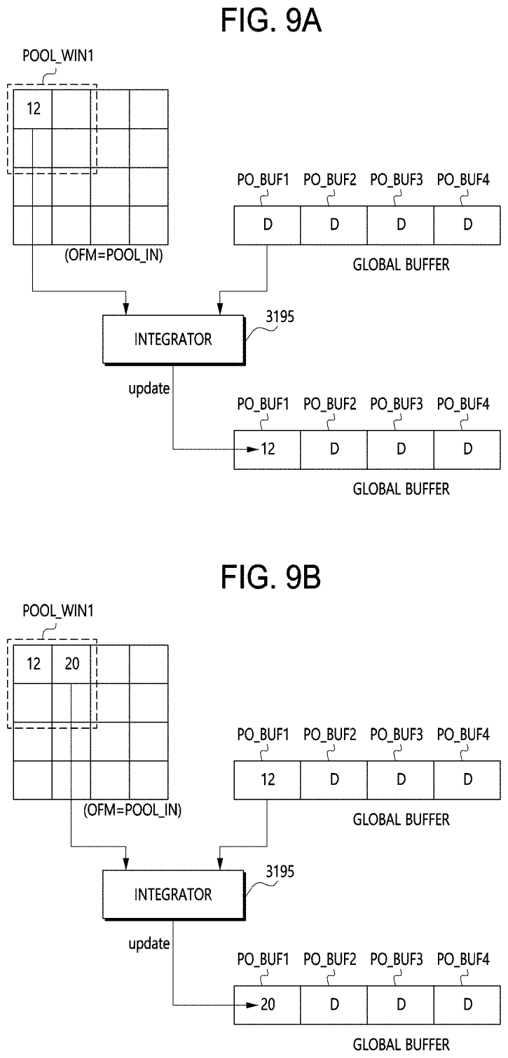

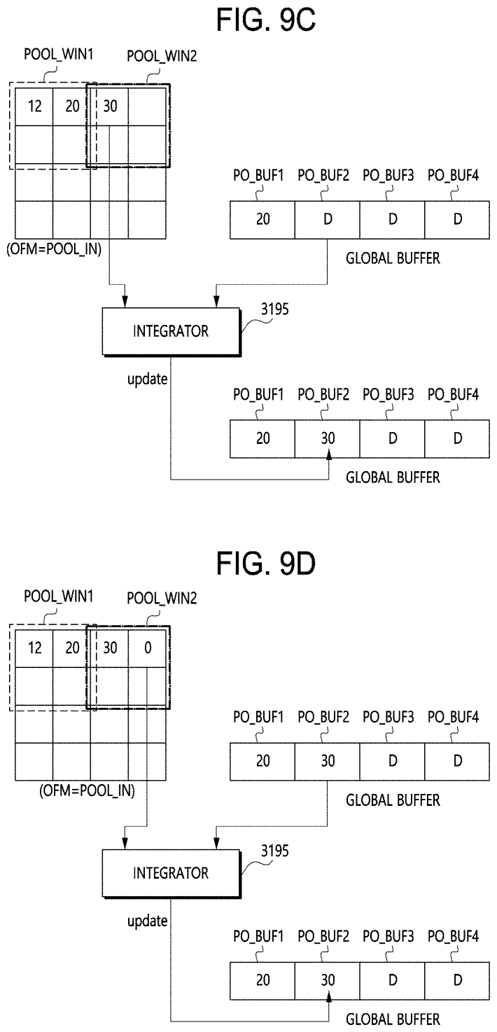

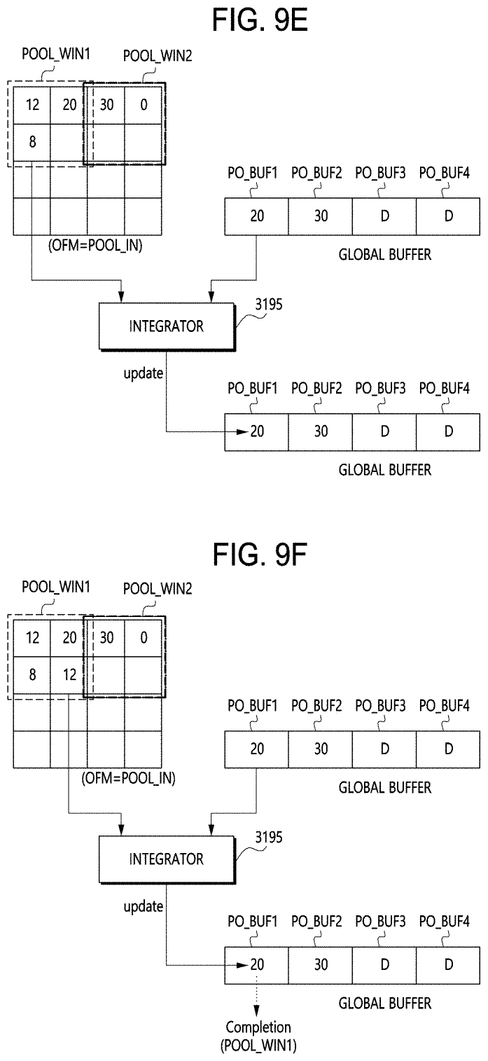

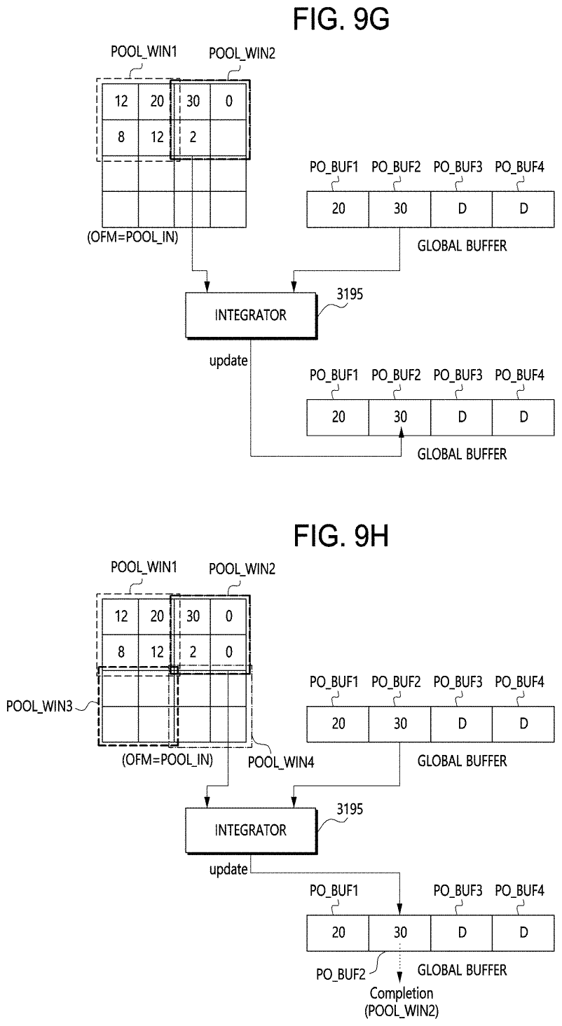

FIG. 9A to FIG. 9H illustrate the concept of data reuse in accordance with an embodiment.

Referring to FIG. 9A to FIG. 9H, respective elements of an output feature map OFM are outputted in the order in which a convolution layer performs a unit convolution operation on each division map of an input feature map IFM, and are used as pooling input data POOL_IN. Four pooling value storage units PO_BUF1 to PO_BUF4 respectively for four pooling windows POOL_WIN1 to POOL_WIN4 are included in the global buffer 313 of FIG. 5. Before a pooling operation is started, an initial value “D” may be stored in each of the pooling value storage units PO_BUF1 to PO_BUF4 of the global buffer 313.

Referring to FIG. 9A, a convolution operation result for a first division map may be outputted as a first element “12” of the first pooling window POOL_WIN1 from the computation memory 311 of FIG. 5.

The first element “12” of the first pooling window POOL_WIN1 may be provided as first input data to an integrator 3195.

Meanwhile, the initial value “D” stored in the first pooling value storage unit PO_BUF1 allocated to the first pooling window POOL_WIN1 may be provided as second input data to the integrator 3195.

The integrator 3195 may perform a pooling operation on the first input data “12” and the second input data “D” and update the first pooling value storage unit PO_BUF1 with a result of the pooling operation. The pooling operation may be a maximum value selection operation for selecting a maximum value between the first input data and the second input data.

Referring to FIG. 9B, a subsequent convolution operation result for a second division map may be outputted as a second element “20” of the first pooling window POOL_WIN1.

The second element “20” of the first pooling window POOL_WIN1 may be provided as the first input data to the integrator 3195.

Meanwhile, the immediately preceding pooling value “12” stored in the first pooling value storage unit PO_BUF1 may be provided as the second input data to the integrator 3195.

The integrator 3195 may perform the pooling operation on the first input data “20” and the second input data “12” and update the first pooling value storage unit PO_BUF1 with a result of the pooling operation. In this case, since the pooling operation is the maximum value selection operation, the first input data “20” is determined as the result of the pooling operation, and the first pooling value storage unit PO_BUF1 is updated with the first input data “20.”

Referring to FIG. 9C, a convolution operation result for a third division map may be outputted as a first element “30” of the second pooling window POOL_WIN2 from the computation memory 311.

The first element “30” of the second pooling window POOL_WIN2 may be provided as the first input data to the integrator 3195.

Meanwhile, the initial value “D” stored in the second pooling value storage unit PO_BUF2 allocated to the second pooling window POOL_WIN2 may be provided as the second input data to the integrator 3195.

The integrator 3195 may perform the pooling operation on the first input data “30” and the second input data “D,” and update the second pooling value storage unit PO_BUF2 according to a result of the pooling operation. In this case, since the pooling operation is the maximum value selection operation, the first input data “30” is determined as the result of the pooling operation, and the second pooling value storage unit PO_BUF2 is updated with the first input data “30.”

Referring to FIG. 9D, a subsequent convolution operation result for a fourth division map may be outputted as a second element “0” included in the second pooling window POOL_WIN2.

The second element “0” of the second pooling window POOL_WIN2 may be provided as the first input data to the integrator 3195.

Meanwhile, the immediately preceding pooling value “30” stored in the second pooling value storage unit PO_BUF2 may be provided as the second input data to the integrator 3195.

The integrator 3195 may perform the pooling operation on the first input data “0” and the second input data “30,” and update the second pooling value storage unit PO_BUF2 according to a result of the pooling operation. In this case, since the pooling operation is the maximum value selection operation, the second input data “30” is determined as the result of the pooling operation, and the second pooling value storage unit PO_BUF2 is updated with the second input data “30.”

Referring to FIG. 9E, a convolution operation result for a fifth division map may be outputted as a third element “8” of the first pooling window POOL_WIN1 from the computation memory 311.

The third element “8” of the first pooling window POOL_WIN1 may be provided as the first input data to the integrator 3195.

Meanwhile, the immediately preceding pooling value “20” stored in the first pooling value storage unit PO_BUF1 may be provided as the second input data to the integrator 3195.

The integrator 3195 may perform the pooling operation on the first input data “8” and the second input data “20,” and update the first pooling value storage unit PO_BUF1 according to a result of the pooling operation. In this case, since the pooling operation is the maximum value selection operation, the second input data “20” is determined as the result of the pooling operation, and the first pooling value storage unit PO_BUF1 is updated with the second input data “20.”

Referring to FIG. 9F, a subsequent convolution operation result for a sixth division map may be outputted as a fourth element “12” included in the first pooling window POOL_WIN1.

The fourth element “12” of the first pooling window POOL_WIN1 may be provided as the first input data to the integrator 3195.

Meanwhile, the immediately preceding pooling value “20” stored in the first pooling value storage unit PO_BUF1 may be provided as the second input data to the integrator 3195.

The integrator 3195 may perform the pooling operation on the first input data “12” and the second input data “20,” and update the first pooling value storage unit PO_BUF1 according to a result of the pooling operation. In this case, since the pooling operation is the maximum value selection operation, the second input data “20” is determined as the result of the pooling operation, and the first pooling value storage unit PO_BUF1 is updated with the second input data “20.”

Accordingly, as described above with reference to FIGS. 9A, 9B, 9E, and 9F, the pooling operation on the first pooling window POOL_WIN1 may be completed.

Referring to FIG. 9G, a convolution operation result for a seventh division map may be outputted as a third element “2” included in the second pooling window POOL_WIN2.

The third element “2” of the second pooling window POOL_WIN2 may be provided as the first input data to the integrator 3195.

Meanwhile, the immediately preceding pooling value “30” stored in the second pooling value storage unit PO_BUF2 may be provided as the second input data to the integrator 3195.

The integrator 3195 may perform the pooling operation on the first input data “2” and the second input data “30,” and update the second pooling value storage unit PO_BUF2 according to a result of the pooling operation. In this case, since the pooling operation is the maximum value selection operation, the second input data “30” is determined as the result of the pooling operation, and the second pooling value storage unit PO_BUF2 is updated with the second input data “30.”

Referring to FIG. 9H, a subsequent convolution operation result for an eighth division map may be outputted as a fourth element “0” included in the second pooling window POOL_WIN2.

The fourth element “0” of the second pooling window POOL_WIN2 may be provided as the first input data to the integrator 3195.

Meanwhile, the immediately preceding pooling value “30” stored in the second pooling value storage unit PO_BUF2 may be provided as the second input data to the integrator 3195.

The integrator 3195 may perform the pooling operation on the first input data “0” and the second input data “30,” and update the second pooling value storage unit PO_BUF2 according to a result of the pooling operation. In this case, since the pooling operation is the maximum value selection operation, the second input data “30” is determined as the result of the pooling operation, and the second pooling value storage unit PO_BUF2 is updated with the second input data “30.”

As for the third pooling window POOL_WIN3 and the fourth pooling window POOL_WIN4, the pooling operation and the update of the third pooling value storage unit PO_BUF3 and the fourth pooling value storage unit PO_BUF4 may be completed in the same manner as the aforementioned method.

In a neural network processor that processes a large amount of data, the present technology can minimize power consumption and a data storage space, and improve a data processing speed, thereby enabling an efficient neural network computation.

A person skilled in the art to which the present disclosure pertains can understand that the present disclosure may be carried out in other specific forms without changing its technical spirit or essential features. Therefore, it should be understood that the embodiments described above are illustrative in all respects, not limitative. The scope of the present disclosure is defined by the claims to be described below rather than the detailed description, and it should be construed that the meaning and scope of the claims and all modifications or modified forms derived from the equivalent concept thereof are included in the scope of the present disclosure.

What is claimed is:

1. A data processing system comprising:
a controller configured to receive a request including an input feature map and a weight filter from a host device, wherein the request is for processing a neural network computation; and
a computation device including a storage unit allocated to each of a plurality of integration groups, and configured to perform a convolution operation on the input feature map and the weight filter, sequentially output a plurality of pooling elements as a result of the convolution operation, and perform a pooling operation on the plurality of pooling elements, the plurality of pooling elements corresponding to each of the plurality of integration groups,
wherein the computation device is configured to perform the pooling operation by:
integrating a pooling value read from the storage unit and each of the plurality of pooling elements into a single value; and
updating the pooling value stored in the storage unit with a result of the integrating,
wherein the integrating and the updating are repeated until all of the plurality of pooling elements are integrated.

2. The data processing system according to claim 1, wherein the input feature map is divided into a plurality of division maps, and
wherein the computation device comprises:
a computation memory configured to sequentially perform the convolution operation on each of the plurality of division maps and the weight filter, and sequentially output, as the plurality of pooling elements, a result of the convolution operation for the plurality of division maps;
a global buffer including the storage unit;
a pooling controller configured to sequentially provide a pooler with the plurality of pooling elements outputted from the computation memory, and update the pooling value stored in the storage unit according to a result of the pooling operation of the pooler; and
the pooler configured to perform the pooling operation when the plurality of pooling elements are sequentially provided to the pooler.

3. The data processing system according to claim 2, wherein the input feature map is provided in the form of a matrix and the weight filter is provided in the form of a matrix, each of the plurality of division maps having the same size as the weight filter.

4. The data processing system according to claim 1, wherein the computation device includes a plurality of processing elements that perform the convolution operation on the input feature map and the weight filter, and
each of the plurality of processing elements includes a plurality of subarrays, each of which includes a unit cell including a memristor element.

5. The data processing system according to claim 1, wherein the integrating includes determining, as the single value, a maximum value between the pooling value and said each of the plurality of pooling elements or an average value of the pooling value and said each of the plurality of pooling elements, and
wherein the updating includes updating the pooling value stored in the storage unit with the maximum value or the average value.

6. A data processing system comprising:
a computation memory configured to receive a request including an input feature map and a weight filter from a host device, sequentially perform a convolution operation on the weight filter and each of a plurality of division maps included in the input feature map, and sequentially output each of a plurality of pooling elements as a result of the convolution operation;
a global buffer including a storage unit allocated to each of a plurality of integration groups, the plurality of pooling elements corresponding to each of the plurality of integration groups;
a pooling controller configured to receive each of the plurality of pooling elements from the computation memory, read out a pooling value from the storage unit, and provide said each of the plurality of pooling elements and the pooling value to a pooler; and
the pooler configured to integrate said each of the plurality of pooling elements and the pooling value into a single value, so that the pooling value stored in the storage unit is updated with a result of the integrating,
wherein the integrating and the updating are repeated until all of the plurality of pooling elements are integrated.

7. The data processing system according to claim 6, wherein the pooling controller comprises:
a buffer allocator configured to allocate the storage unit to each of the plurality of integration groups;
a pooling map configuration circuit configured to classify the pooling elements; and
an updater configured to update the pooling value of the storage unit according to a pooling result outputted from the pooler.

8. The data processing system according to claim 6, wherein the computation memory includes a plurality of processing elements that perform the convolution operation on the weight filter and each of the plurality of division maps, and
each of the plurality of processing elements includes a plurality of subarrays, each of which includes a unit cell including a memristor element.

9. The data processing system according to claim 6, wherein the pooler is configured to determine, as the single value, a maximum value between the pooling value and said each of the plurality of pooling elements or an average value of the pooling value and said each of the plurality of pooling elements.

10. An operating method of a data processing system, the operating method comprising:
allocating, by a controller, a storage unit to each of a plurality integration groups;
receiving, by the controller, a request including an input feature map and a weight filter from a host device;
performing, by a computation device, a convolution operation on the input feature map and the weight filter;
sequentially outputting, by the computation device, a plurality of pooling elements as a result of performing the convolution operation, the plurality of pooling elements corresponding to each of the plurality of integration groups;
integrating, by the computation device, a pooling value read from the storage unit and each of the plurality of pooling elements into a single value; and
updating, by the computation device, the pooling value of the storage unit according to a result of the integrating,
wherein the integrating and the updating are repeated until all of the plurality of pooling elements are integrated.

11. The operating method according to claim 10, wherein the performing of the convolution operation comprises:
sequentially performing the convolution operation on each of a plurality of division maps and the weight filter, the input feature map being divided into the plurality of division maps.

12. The operating method according to claim 11, wherein each of the input feature map and the weight filter is provided in the form of a matrix, each of the plurality of division maps having the same size as the weight filter.

13. The operating method according to claim 10, wherein the computation device includes a plurality of processing elements that perform the convolution operation, and
each of the plurality of processing elements includes a plurality of subarrays, each of which includes a unit cell including a memristor element.

14. The operating method according to claim 10, wherein the integrating comprises:
determining, as the single value, a maximum value between the pooling value and said each of the plurality of pooling elements or an average value of the pooling value and said each of the plurality of pooling elements.

15. A computing system comprising:
a host device; and
a data processing system configured to:
receive a request including an input feature map and a weight filter from the host device;
perform a convolution operation on the input feature map and the weight filter;
sequentially output a plurality of pooling elements as a result of performing the convolution operation, the plurality of pooling elements corresponding to each of a plurality of integration groups;
allocate a storage unit to each of the plurality of integration groups;
integrate a pooling value read from the storage unit and each of the plurality of pooling elements into a single value; and
update the pooling value stored in the storage unit with a result of the integrating,
wherein the integrating and the updating are repeated until all of the plurality of pooling elements are integrated.

16. The computing system according to claim 15, wherein the data processing system comprises:
a computation memory configured to sequentially perform a convolution operation on the weight filter and each of a plurality of division maps constituting the input feature map, and sequentially output each of the plurality of pooling elements as a result of performing the convolution operation;
a global buffer including the storage unit;
a pooling controller configured to sequentially provide a pooler with the pooling elements for each of the plurality of integration groups outputted from the computation memory, and update the pooling value of the storage unit according to a result of a pooling operation of the pooler; and
the pooler configured to perform the pooling operation when the plurality of pooling elements for each of the plurality of integration groups are provided.

17. The computing system according to claim 16, wherein the input feature map is provided in the form of a matrix and the weight filter is provided in the form of a matrix, each of the plurality of division maps having the same size as the weight filter.

18. The computing system according to claim 15, wherein the data processing system includes a plurality of processing elements that perform the convolution operation, and
each of the plurality of processing elements includes a plurality of subarrays, each of which includes a unit cell including a memristor element.

19. The computing system according to claim 15, wherein the data processing system is configured to determine, as the single value, a maximum value between the pooling value and said each of the plurality of pooling elements or an average value of the pooling value and said each of the plurality of pooling elements.
